(19) United States
(12) Patent Application Publication
(10) Pub. No.: US 2023/0392692 A1
(43) Pub. Date: Dec. 7, 2023

(54) SEAL ASSEMBLY

(71) Applicant: Joel Gale, Bowmanville (CA)

(72) Inventor: Joel Gale, Bowmanville (CA)

(21) Appl. No.: 17/830,492

(22) Filed: Jun. 2, 2022

(51) Int. Cl. F16J 15/10

(52) U.S. Cl. CPC F16J 15/104

(57) ABSTRACT

The disclosed seal assembly according to various aspects of the subject technology may form a fluid-tight seal between an elongated member and an enclosure carrying the elongated member. The seal assembly may include an expandable body portion and an expansion component. The body portion may include a first aperture for receiving the elongated member therethrough, a second aperture for receiving the expansion component therethrough, and an outer surface to be positioned against an interior surface of the enclosure when the body portion expands within the enclosure. The expansion component may be configured to apply a radially-expansive force to the body portion when inserted into the second aperture.

### BACKGROUND OF THE INVENTION

There are many applications in which it is necessary or desirable to connect a variety of cables that are buried within a foundation of a structure or located within an underground manhole or vault to various electrical equipment and systems located at a distance away from the point at which the cables emerge from the foundation, manhole or vault. The cables are typically placed within and along a hollow conduit or duct, which itself may be cast within the foundation, manhole or vault, and the opening or space between the cables and the conduit or duct is typically sealed using a seal assembly at the point at which the cables emerge from the conduit or duct.

A conventional sealing assembly generally includes a threaded fitting attached to the conduit or duct, a bushing through which the cables are fed, and a threaded cap which surrounds the bushing and is screwed onto the fitting, causing the bushing to compress around the cables to form a seal between the cables and the conduit or duct. However, small openings or spaces between and around the cables themselves can still remain, allowing hazardous gases and vapors, water, and other liquids, and even pests and rodents to enter the conduit or duct, thereby potentially damaging the cables.

Accordingly, what is needed is a seal assembly that is easy to install and that forms a fluid-tight seal between the cables and the conduit or duct carrying the cables by preventing hazardous gases and vapors, water, moisture, dust, debris, and rodents from entering the conduit or duct so that the electrical equipment connected to the cables is protected and personnel responsible for operating and/or repairing the electrical equipment are provided with a safe environment.

### SUMMARY OF THE TECHNOLOGY

The disclosed seal assembly according to various aspects of the subject technology may form a fluid-tight seal between an elongated member and an enclosure carrying the elongated member. The seal assembly may comprise an expandable body portion and an expansion component. The body portion may comprise a first aperture for receiving the elongated member therethrough, a second aperture for receiving the expansion component therethrough, and an outer surface to be positioned against an interior surface of the enclosure when the body portion expands within the enclosure. The expansion component may be configured to apply a radially-expansive force to the body portion when inserted into the second aperture.

### BRIEF DESCRIPTION OF THE DRAWINGS

A more complete understanding of the subject technology may be derived by referring to the detailed description when considered in connection with the following illustrative figures. In the following figures, like reference numbers refer to similar elements and steps throughout the figures.

FIG. 1 representatively illustrates a seal assembly in accordance with an embodiment of the subject technology;

FIG. 2 representatively illustrates a seal assembly in accordance with an embodiment of the subject technology;

FIG. 3 representatively illustrates a side view of a seal assembly installed within an enclosure in accordance with an embodiment of the subject technology;

FIG. 4 representatively illustrates a side view of a seal assembly installed within an enclosure in accordance with an embodiment of the subject technology; and

FIG. 5 representatively illustrates a flow diagram for operating a seal assembly in accordance with an embodiment of the subject technology.

### DETAILED DESCRIPTION OF EMBODIMENTS

The subject technology may be described in terms of functional components. Such functional components may be realized by any number of components configured to perform the specified functions and achieve the various results. For example, the subject technology may employ various seals, tubular bodies, inserts, expansion components, and the like, which may carry out a variety of functions. In addition, the subject technology may be practiced in conjunction with any one of various elongated members and enclosures, and the seal assembly described herein is merely one exemplary application for the technology.

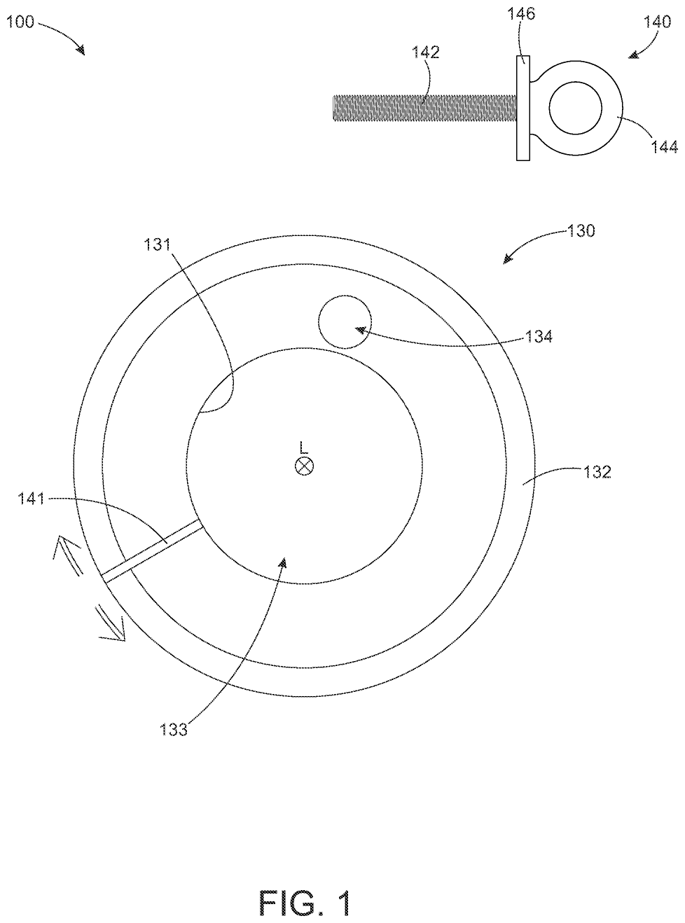

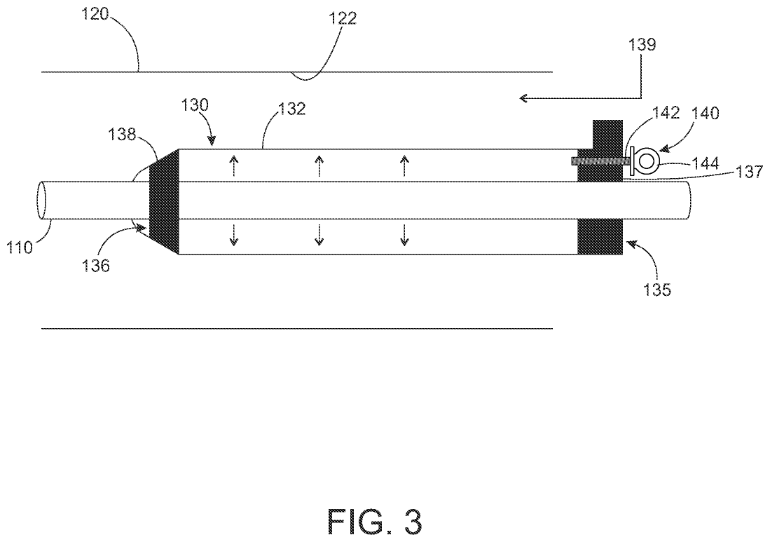

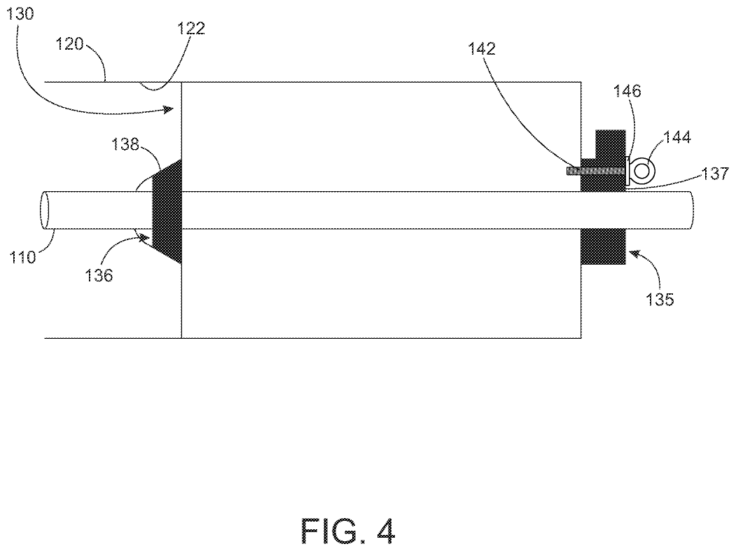

Referring to FIGS. 1-4, an exemplary seal assembly 100 may enclose an elongated member 110 and may be fitted inside an enclosure 120 carrying the elongated member 110 to provide a fluid-tight seal between the elongated member 110 and the enclosure 120. For the purposes of this Application, “fluid-tight seal” means a “water-tight seal,” a “moisture-tight seal,” an “air-tight seal,” a “gas-tight seal,” a “vapor-tight seal,” and the like. As generally used herein, an “elongated member” includes, but is not limited to, any type of cable, such as a conductor, electrical cable, fiber optic cable, wire, and the like. Furthermore, an “enclosure” is any type of enclosure for housing the elongated member 110, such as a duct, a PVC conduit, a metal conduit, a ceramic conduit, a pipe, a tube, and the like. The seal assembly 100 may protect various electrical equipment connected to the elongated member 110 and provide a safe operating environment for personnel responsible for maintaining and/or repairing the electrical equipment by preventing hazardous gases and vapors, water, moisture, dust, debris, and rodents from entering the enclosure 120 and damaging the elongated member 110. According to various embodiments, the seal assembly 100 may comprise a body portion 130 and an expansion component 140.

The body portion 130 may comprise an inner surface 131 and an outer surface 132. The inner surface 131 may define a first aperture 133 in the body portion 130 for receiving the elongated member 110 therethrough. In addition, the body portion 130 may comprise a second aperture 134 for receiving the expansion component 140 therethrough. The outer surface 132 may be configured to be positioned against an interior surface 122 of the enclosure 120 when the body portion 130 is fitted inside the enclosure 120 and subsequently expanded within the enclosure 120. The body portion 130 may be constructed from any suitable non-conductive material, such as rubber, silicone, plastic, and the like.

The body portion 130 may further comprise a first open end 135 and a second open end 136 opposite the first open end 135. The first open end 135 may terminate in a peripheral annular edge 137 and the second open end 136 may terminate in a tapered edge 138 to allow the body portion 130 to slidably guide with respect to the interior surface 122 of the enclosure 120. In some embodiments, the body portion 130 may comprise a radial cut 141 formed in a plane perpendicular to a central longitudinal axis L of the body portion 130 to permit the body portion 130 to open radially outward so that the elongated member 110 may be placed within the body portion 130.

The body portion 130 may be of any suitable size or shape such as a tubular-shaped body, a cylindrical-shaped body, a cubic-shaped body, or a rectangular-shaped body, or any shape that may generally conform to the shape of the enclosure 120. The width of the body portion 130 may be less than the width of the enclosure 120, such that the outer surface 132 of the body portion 130 and the interior surface 122 of the enclosure 120 may define a gap 139 therebetween when the body portion 130 is inserted into the enclosure 120. Accordingly, the body portion 130 may slidably guide with respect to the interior surface 122 of the enclosure 120 when inserted therein.

In various embodiments, the inner surface 131 of the body portion 130 may comprise a curved surface to better conform to a curvature of the elongated member 110 to permit convenient positioning of the elongated member 110 through the first aperture 133. Similarly, the outer surface 132 of the body portion 130 may comprise a curved surface to better conform to a curvature of the interior surface 122 of the enclosure 120 when the body portion 130 is fitted inside the enclosure 120. The inner surface 131 and the outer surface 132 may, however, be shaped in any suitable manner to engage the elongated member 110 and the interior surface 122 of the enclosure 120, respectively.

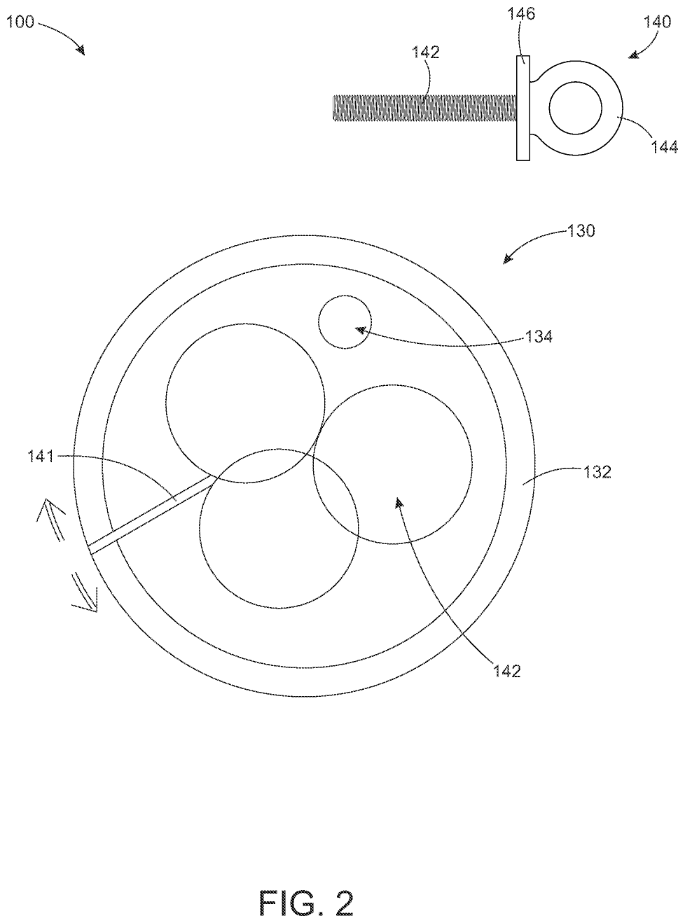

It will be appreciated that modifications may be made to the body portion 130 without departing from the scope of the invention. For example, instead of the first aperture 133, the body portion 130 may comprise a plurality of apertures 142, such as shown in FIG. 2. Each aperture 142 may be configured to receive a respective one of a plurality of elongated members (not shown) therethrough. The plurality of apertures 142 may be equidistant from the central longitudinal axis L of the body portion 130 and spaced equidistantly apart from each other. The plurality of apertures 142 may, however, be positioned in any suitable manner for receiving the plurality of elongated members therethrough.

The expansion component 140 may comprise any suitable apparatus, system, device, tool, or mechanical component that is capable of applying a radially-expansive force to the body portion 130, such as a key, plug, bolt, pin, rivet, screw, and the like. As an example, in one embodiment, the expansion component 140 may comprise a screw 142, a handle 144, and a stopper 146 therebetween. The expansion component 140 may be coupled to the body portion 130 by pressing it towards the body portion 130 and inserting it through the second aperture 134 and then turning or twisting it to apply a radially-expansive force to the body portion 130. The screw 142 may be inserted into the second aperture 134 until the stopper 146 abuts the body portion 130. Conversely, the expansion component 140 may be decoupled from the body portion 130 by twisting it into an unlocked position and then disengaging it from the body portion 130.

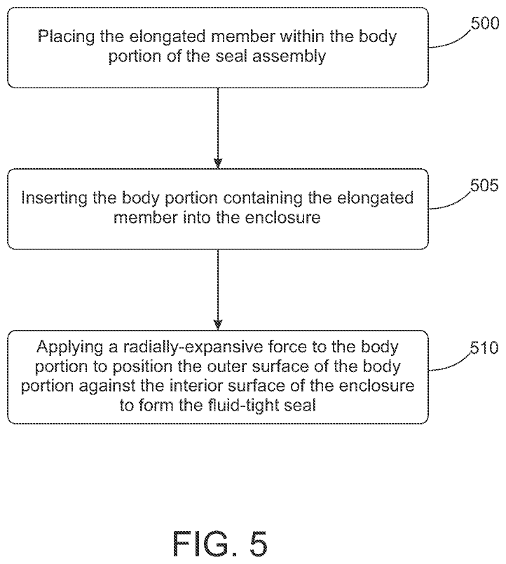

In operation, and referring now to FIGS. 1-5, using the seal assembly 100 to form the fluid-tight seal between the elongated member 110 and the enclosure 120 carrying the elongated member 110 may comprise placing the elongated member 110 within the body portion 130 of the seal assembly 100 (500). The elongated member 110 may be placed within the body portion 130 in any suitable manner. For example, the elongated member 110 may be fed through the first aperture 133 via the first open end 135 of the body portion 130. Alternatively, the body portion 130 may be opened radially outward via the cut 138 and the elongated member 110 may be placed therein. Using the seal assembly 100 to form the fluid-tight seal between the elongated member 110 and the enclosure 120 may also comprise inserting the body portion 130 containing the elongated member 110 into the enclosure 120 (505). Using the seal assembly 100 to form the fluid-tight seal between the elongated member 110 and the enclosure 120 may further comprise applying a radially-expansive force to the body portion 130 to position the outer surface 132 of the body portion 130 against the interior surface 122 of the enclosure 120 (510). The radially-expansive force may be applied to the body portion 130 in any suitable manner, such as by pressing the expansion component 140 towards the body portion 130 and inserting it through the second aperture 134 of the body portion 130. The expansion component 140 may then be turned to apply the radially-expanding force to the body portion 130 until the outer surface 132 of the body portion 130 is flush with the interior surface 122 of the enclosure 120.

The particular implementations shown and described are illustrative of the technology and its best mode and are not intended to otherwise limit the scope of the subject technology in any way. Indeed, for the sake of brevity, conventional manufacturing, connection, preparation, and other functional aspects of the apparatus may not be described in detail. Furthermore, the connections and points of contact shown in the various figures are intended to represent exemplary physical relationships between the various elements. Many alternative or additional functional relationships or physical connections may be present in a practical system.

In the foregoing description, the technology has been described with reference to specific exemplary embodiments. Various modifications and changes may be made, however, without departing from the scope of the subject technology as set forth. The description and figures are to be regarded in an illustrative manner, rather than a restrictive one and all such modifications are intended to be included within the scope of the subject technology. Accordingly, the scope of the technology should be determined by the generic embodiments described and their legal equivalents rather than by merely the specific examples described above. For example, the components and/or elements recited in any apparatus embodiment may be combined in a variety of permutations to produce substantially the same result as the subject technology and are accordingly not limited to the specific configuration recited in the specific examples.

Benefits, other advantages, and solutions to problems have been described above with regard to particular embodiments. Any benefit, advantage, solution to problems or any element that may cause any particular benefit, advantage, or solution to occur or to become more pronounced, however, is not to be construed as a critical, required, or essential feature or component.

The terms “comprises,” “comprising,” or any variation thereof, are intended to reference a non-exclusive inclusion, such that a process, method, article, composition, or apparatus that comprises a list of elements does not include only those elements recited but may also include other elements not expressly listed or inherent to such process, method, article, composition, or apparatus. Other combinations and/or modifications of the above-described structures, arrangements, applications, proportions, elements, materials, or components used in the practice of the subject technology, in addition to those not specifically recited, may be varied, or otherwise particularly adapted to specific environments, manufacturing specifications, design parameters or other operating requirements without departing from the general principles of the same.

The subject technology has been described above with reference to an exemplary embodiment. However, changes and modifications may be made to the exemplary embodiment without departing from the scope of the subject technology. These and other changes or modifications are intended to be included within the scope of the subject technology.

1. A seal assembly for forming a fluid-tight seal between an elongated member and an enclosure carrying the elongated member, comprising:
an expandable body portion, comprising:
a first aperture for receiving the elongated member therethrough;
a second aperture; and
an outer surface to be positioned against an interior surface of the enclosure when the body portion expands within the enclosure; and
an expansion component configured to apply a radially-expansive force to the body portion when inserted into the second aperture.

2. The seal assembly of claim 1, wherein the body portion comprises a tubular-shaped body, and wherein the tubular-shaped body comprises:
a first open end terminating in a peripheral annular edge;
a second open end terminating in a tapered edge; and
a radial cut formed perpendicular to a central longitudinal axis of the tubular-shaped body to permit the tubular-shaped body to open radially outward.

3. The seal assembly of claim 1, wherein the expansion component comprises at least one of a key, plug, bolt, pin, or screw.

4. The seal assembly of claim 2, wherein the tubular-shaped body comprises a non-conductive material.

5. The seal assembly of claim 2, wherein the first end and the second end each comprise a hardened material.

6. The seal assembly of claim 4, wherein the non-conductive material comprises rubber, silicone, plastic, or a combination thereof.

7. The seal assembly of claim 5, wherein the hardened material comprises aluminum, iron, steel, or a combination thereof.

8. A method of using a seal assembly to form a fluid-tight seal between an elongated member and an enclosure carrying the elongated member, comprising:
placing the elongated member within a body portion of the seal assembly;
inserting the body portion containing the elongated member into the enclosure; and
applying a radially-expansive force to the body portion to position an outer surface of the body portion against an interior surface of the enclosure to form the fluid-tight seal.

9. The method of claim 8, wherein placing the elongated member within the body portion comprises inserting the elongated member through a first aperture of the body portion.

10. The method of claim 8, wherein applying the radially-expansive force to the body portion comprises pressing an expansion component of the seal assembly towards the body portion and inserting the expansion component through a second aperture of the body portion.

11. The method of claim 10, wherein the expansion component comprises at least one of a key, plug, bolt, pin, or screw.
